(19) United States
(12) Patent Application Publication
(10) Pub. No.: US 2005/0204891 A1
(43) Pub. Date: Sep. 22, 2005

(54) Protective cover for the headstock of stringed instruments

(75) Inventor: Michael Cherubini, Somerdale, NJ (US)

Correspondence Address: IP GROUP OF DLA PIPER RUDNICK GRAY CARY US LLP, 1650 MARKET ST, SUITE 4900, PHILADELPHIA, PA, 19103, US

(73) Assignee: Cherubini Development Corporation, LLC, Somerdale, NJ (US)

(21) Appl. No.: 11/083,495

(22) Filed: Mar. 18, 2005

Related U.S. Application Data
(60) Provisional application No. 60/554,098, filed on Mar. 18, 2004.

(51) Int. Cl. G10D 3/00

(52) U.S. Cl. 84/290

(57) ABSTRACT

A protective cover is adapted for stringed instruments to protect the headstock portion. The protective cover comprises an outer body and a cavity within the outer body which enables it to be received onto the end of the headstock.

### CROSS REFERENCE TO RELATED APPLICATIONS

The present application is related to and claims priority to provisional Patent Application Ser. No. 60/554,098 filed Mar. 18, 2004, the entire disclosure of which is incorporated by reference herein.

### FIELD OF THE INVENTION

The present invention relates generally to instruments and more particularly to protection for the headstock of stringed instruments.

### BACKGROUND OF THE INVENTION

Stringed instruments come in a variety of forms, such as electric and acoustic guitars, violins, cellos and upright basses, to name a few. In general, such stringed instruments include a body, a neck extending from the body, a headstock attached to the neck on the end opposite the body and a plurality of tuning mechanisms retained by the headstock. Also included are a plurality of strings, each having one end connected to the body and an opposite end connected to a different tuning mechanism on the headstock.

The headstock is susceptible to being damaged over time, such as from accidental contact with walls, floors, stools or other instruments during use. The damage, at a minimum, can adversely affect the overall appearance of the instrument, which is undesirable at any time, but especially with regard to high end or vintage instruments. Severe enough damage can affect the overall operation of the instrument, such as by adversely affecting the sound or by making it difficult if not impossible to properly tune the instrument.

The present invention has been developed in view of the deficiencies noted with respect to the headstock portion of stringed instruments.

### SUMMARY OF THE INVENTION

The present invention provides a protective cover for the headstock of stringed instruments. The protective cover may be configured to be used with various types of stringed instruments as well as headstocks of different shapes. In one embodiment, a protective cover comprises a body having an outer surface and a cavity within the outer surface adapted for being received upon a portion of the headstock of a stringed instrument.

### BRIEF DESCRIPTION OF THE DRAWINGS

FIG. 1 is a front elevational view of an embodiment of a protective cover in accordance with the present invention.

FIG. 1a is an isolated front elevational view of the protective cover of FIG. 1.

FIG. 1b is a bottom plan view of the protective cover of FIG. 1.

FIG. 2 is another embodiment of a protective cover in accordance with the present invention.

FIG. 3 is another embodiment of a protective cover in accordance with the present invention.

FIG. 4 is another embodiment of a protective cover in accordance with the present invention.

FIG. 5 is another embodiment of a protective cover in accordance with the present invention.

FIG. 6 is another embodiment of a protective cover in accordance with the present invention.

FIG. 7 is another embodiment of a protective cover in accordance with the present invention.

FIG. 8 is another embodiment of a protective cover in accordance with the present invention.

FIG. 9 is another embodiment of a protective cover in accordance with the present invention.

FIG. 10 is another embodiment of a protective cover in accordance with the present invention.

FIG. 11 is another embodiment of a protective cover in accordance with the present invention.

FIG. 12 is another embodiment of a protective cover in accordance with the present invention.

FIG. 13 is another embodiment of a protective cover in accordance with the present invention.

FIG. 14 is another embodiment of a protective cover in accordance with the present invention.

### DESCRIPTION OF THE INVENTION

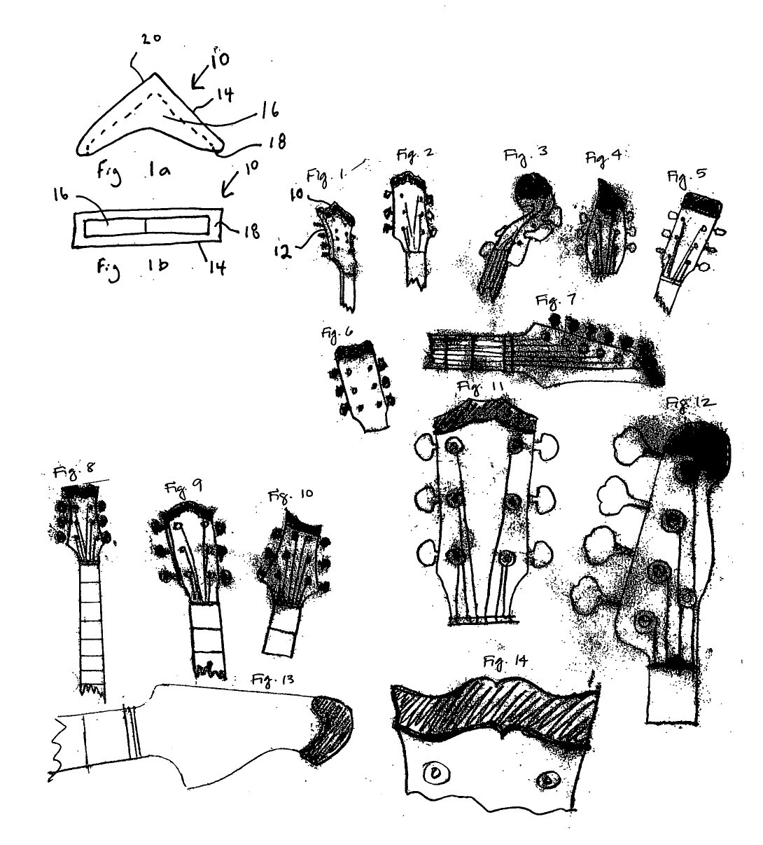

Referring now to the drawings in detail, wherein like reference numerals correspond to like elements throughout the several views, there is illustrated in the accompanying drawings various embodiments of a protective cover for stringed instruments in accordance with the present invention. For illustration purposes, a protective cover 10 is shown in FIG. 1 and is preferably configured so as to be received onto the end of the headstock portion 12 of a stringed instrument. As mentioned earlier, the headstock portion of a stringed instrument is typically a very fragile and vulnerable part of the instrument and is often susceptible to damage.

The term “stringed instrument” as used herein should be broadly construed to comprise a variety of instruments, such as, for example and without limitation, electric and acoustic guitars, violins, cellos and upright basses, to name a few. In addition, in other embodiments, it should be understood that the protective cover can also be utilized with other types of instruments that are not stringed as may be appropriate.

As shown in the isolated views of FIGS. 1a and 1b, the protective cover 10 comprises a body portion 14 and a cavity 16 within an outer surface of the body portion 14. In this embodiment, the cavity 16 is within a bottom surface 18 of the body portion 14 into which the headstock is received. The body portion 14 of the protective cover 10 may comprise any desired shape. In the present embodiment, the body portion 14 includes a top surface 20 that is generally v-shaped in configuration, and the bottom surface 18 is substantially curved inwardly toward the top surface 20. In addition, in this embodiment, the cavity 16 is v-shaped in configuration corresponding to the top surface 20. As should be understood, however, any other desired shapes for the top surface 20, bottom surface 18 and/or cavity 16 may be utilized.

In certain embodiments, where desired, the body portion and/or the associated cavity may be configured to correspond to the shape of a particular headstock or headstocks, such as one specific headstock design or a group of specific headstock designs, such as based on headstock designs offered by a particular manufacturer. In particular embodiments, this can be done for merely aesthetic reasons, for functional reasons, or a combination of both. For example, the shape of the cavity 16 may be formed to substantially correspond to the shape of the end portion of a certain headstock design, which may facilitate the mounting of the protective cover, help retain the protective cover in the mounted position, and/or regulate the amount of the headstock that is visible outside of the protective cover, etc. Similarly, as an another example, the top surface 20 may be formed to substantially correspond to the shape of the end portion of a certain headstock design, such as for appearance reasons and/or to provide improved support when the instrument is leaned against a wall, etc.

In other embodiments, the body portion and/or the associated cavity can be formed so as to be more generic, in that the design does not take any particular headstock configuration into consideration, but rather is designed to have the versatility to be utilized with various headstock configurations. Similar to that mentioned above, the design of the body portion and/or the cavity in various embodiments can take into consideration aesthetics, functionality or a combination of both. For example, a certain cavity configuration may be utilized that may be more conducive to enable mounting of the protective cover on various different configurations of headstock, or a certain shape of body portion may be utilized that provides an attractive appearance and/or which provides for adequate support for the instrument when leaned against a wall, etc. In certain embodiments, the shape of the body portion can serve as an identifier of source, and operate as a trademark.

In FIGS. 2-14 are illustrated various other exemplary embodiments of protective covers in accordance with the present invention. As should be understood, there are numerous other possible embodiments that are not shown.

The protective cover in accordance with the various embodiments of the present invention may be comprised of any suitable material or materials, such as, for example, a material/composition of materials that are “softer” than the material comprising the headstock, for instance, any suitable elastomeric material, such as neoprene rubber. As should be understood, however, harder materials than the headstock may also be utilized as well where desired. The protective cover according to various embodiments may also include, where desired, indicia on the outer surface of the body portion, such as, for example, a design, pattern, writing and/or artwork.

In addition, in accordance with various embodiments, the protective cover can operate to preserve the value and appearance of stringed instruments by restricting damage to the headstock. The versatility of the protective cover in certain embodiments is an advantage as it can be used with a variety of different instruments and different configured headstocks, such as, for example, preservation of any vintage instruments or protection of newly purchased instruments. The protective cover can also be used over a worn or “beat-up” headstock where desired, operating to improve the overall appearance. Preferably, the material and composition of the protective cover in certain embodiments is thin enough so as to not interfere with the look of the instrument, yet thick enough to protect from dings and dents that sometimes occur from playing or when propped against a wall, etc. In addition, in various embodiments, preferably the protective cover is stable enough so as to be retained on the headstock when inadvertent contact is made or when an instrument is propped against a wall, yet not leave any mark upon the instrument itself. Additionally, the protective cover may further prevent injury to people and their property by concealing and covering the hard and often fairly sharp edges of the headstock with a softer material.

While the present invention has been described in regards to particular embodiments, it is recognized that additional variations and modifications of the present invention may be devised without departing from the inventive concept. Therefore, the invention in its broader aspects is not limited to specific details shown and described herein. Accordingly, it is intended that the invention not be limited to the specific illustrative embodiments, but be interpreted within the full spirit and scope of the appended claims and their equivalents.

1. A protective cover for a stringed instrument comprising:
a body having an outer surface and a cavity within the outer surface adapted for being received upon a portion of the headstock of a stringed instrument.

2. A protective cover of claim 1, wherein the protective cover is comprised substantially of a material that is softer than the material comprising the headstock.

3. A protective cover of claim 1, wherein the protective cover is comprised of an elastomeric material.

4. A protective cover of claim 1, wherein the body further comprises a top surface and a bottom surface, with at least one of the top surface or bottom surface being configured based on at least one of functional considerations or aesthetic considerations.

5. A protective cover of claim 4, wherein at least one of the top surface of the body or cavity within the outer surface is configured to correspond generally to the configuration of the end portion of the headstock.

6. A method for protecting the headstock of an instrument comprising:
providing a protective cover comprising a body having an outer surface and a cavity within the outer surface; and
mounting the protective cover on the instrument so that the end of the headstock is received within the cavity of the protective cover.

7. A method according to claim 6, further comprising providing the protective cover comprised substantially of an elastomeric material.

8. A method according to claim 6, wherein the protective cover further comprises a top surface and a bottom surface, with the cavity being provided within the bottom surface, and at least one of the top surface or bottom surface being configured based on at least one of aesthetic characteristics or functional characteristics.

9. A musical instrument comprising:
a body;
a neck attached at a first end to the body;
a headstock attached at a first end to a second end of the neck; and
a protective cover having an outer body and a cavity within the outer body, with the cavity being received over a second end of the headstock.

10. A musical instrument according to claim 9, wherein the protective cover is comprised substantially of a material that is softer than the material comprising the headstock.

11. A musical instrument according to claim 10, wherein the protective cover is comprised of an elastomeric material.

12. A musical instrument according to claim 9, wherein the protective cover further comprises a top surface and a bottom surface, with at least one of the top surface or bottom surface being configured based on at least one of functional considerations or aesthetic considerations.

13. A musical instrument according to claim 12, wherein at least one of the top surface or cavity within the outer body is configured to correspond generally to the configuration of the second end of the headstock.
